(19) United States
(12) Patent Application Publication
(10) Pub. No.: US 2021/0173808 A1
(43) Pub. Date: Jun. 10, 2021

(54) EARLY PARITY ERROR DETECTION ON AN I3C BUS

(71) Applicant: QUALCOMM Incorporated, San Diego, CA (US)

(72) Inventors: Subramanian Kizhakkenchery ANANTHANARAYANAN, Hyderabad (IN); Joy CHAKRABORTY, Hyderabad (IN); Arun GOTHEKAR, Hyderabad (IN)

(21) Appl. No.: 16/703,720

(22) Filed: Dec. 4, 2019

(51) Int. Cl. G06F 13/42; G06F 13/40; G06F 11/10; G06F 11/07; G06F 9/46

(52) U.S. Cl. CPC G06F 13/4295; G06F 13/4072; G06F 9/466; G06F 11/076; G06F 11/1004

(57) ABSTRACT

Systems, methods, and apparatus for serial bus arbitration are described. A method for managing transactions executed on a serial bus includes configuring a slave device coupled to the serial bus with information identifying a first number to be used to count data bytes, initiating a first transaction to transmit a block of data that has a second number of data bytes to the slave device, the second number being greater than the first number, and providing an opportunity for the slave device to acknowledge receipt of an immediately preceding first number of data bytes after an integer multiple of the first number of data bytes has been transmitted.

### TECHNICAL FIELD

The present disclosure relates generally to a serial bus interface between processing circuits and peripheral devices and, more particularly, to reporting parity errors in a block of data before completion of transmission of the block of data.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol, such as an Inter-Integrated Circuit (I2C bus or I²C) protocol. I2C protocols were developed to provide a support a multi-drop bus architecture used to connect low-speed peripherals to a processor. A two-wire I2C bus includes a Serial Data Line (SDA) that carries a data signal, and a Serial Clock Line (SCL) that carries a clock signal. Original implementations of I2C protocols supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

A serial bus may employ a multi-master protocol in which one or more devices can serve as a master and a slave for different messages transmitted on the serial bus. For example, Improved Inter-Integrated Circuit (I3C) protocols may be used to control operations on a serial bus. I3C protocols are defined by the Mobile Industry Processor Interface (MIPI) Alliance and derive certain implementation aspects from I2C protocols. Conventional I2C and I3C protocols are used to control half-duplex operations on a serial bus. Throughput and responsiveness of half-duplex serial buses may be affected by bus turnaround delays and an inability of slave devices to communicate control or status messages while receiving data from a bus master device.

### SUMMARY

Certain aspects of the disclosure relate to systems, apparatus, methods and techniques that enable a slave device to report parity errors while receiving large blocks of data in accordance with an I3C protocol.

In various aspects of the disclosure, a method for managing transactions executed on a serial bus includes configuring a slave device coupled to the serial bus with information identifying a first number to be used to count data bytes received from the serial bus, initiating a first transaction to transmit a block of data that has a second number of data bytes to the slave device, the second number being greater than the first number, and providing an opportunity for the slave device to acknowledge receipt of an immediately preceding first number of data bytes after an integer multiple of the first number of data bytes has been transmitted.

In some aspects, the method includes terminating the first transaction when the slave device does not acknowledge receipt of the immediately preceding first number of data bytes, and retransmitting the immediately preceding first number of data bytes in a second transaction. The method may include continuing transmission of the block of data from a location in the block of data at which the opportunity for the slave device to acknowledge receipt of the immediately preceding first number of data bytes was provided, after retransmitting the immediately preceding first number of data bytes.

In one aspect, providing an opportunity for the slave device to acknowledge receipt of an immediately preceding first number of data bytes includes causing an output of a line driver to enter an undriven state after transmitting a last data byte in the integer multiple of the first number of data bytes.

In certain aspects, providing an opportunity for the slave device to acknowledge receipt of an immediately preceding first number of data bytes includes providing an extra data byte for transmission after a last data byte in the integer multiple of the first number of data bytes, transmitting eight bits of the extra data byte after the last data byte in the integer multiple of the first number of data bytes has been transmitted, and providing a ninth bit in the extra data byte by causing an output of a line driver to enter an undriven state. A cyclic redundancy check (CRC) code may be provided in the extra data byte. In one example, the CRC code may be calculated from the immediately preceding first number of data bytes. In another example, the CRC code may be calculated from data bytes in the block of data that have been transmitted before the extra data byte is transmitted. Parity information may be provided in the extra data byte. In some instances, the parity information may be related to the CRC code. In some instances, the parity information may be generated from the immediately preceding first number of data bytes.

In various aspects of the disclosure, an apparatus includes a bus interface configured to couple the apparatus to a serial bus, and a processor. The processor may be configured to configure a slave device coupled to the serial bus with information identifying a first number to be used to count data bytes received from the serial bus, initiate a first transaction to transmit a block of data that has a second number of data bytes to the slave device, the second number being greater than the first number, and provide an opportunity for the slave device to acknowledge receipt of an immediately preceding first number of data bytes after an integer multiple of the first number of data bytes has been transmitted.

In various aspects of the disclosure, a computer-readable medium stores code, instructions and/or data, including code which, when executed by a processor, causes the processor to configure a slave device coupled to a serial bus with information identifying a first number to be used to count data bytes received from the serial bus, initiate a first transaction to transmit a block of data that has a second number of data bytes to the slave device, the second number being greater than the first number, and provide an opportunity for the slave device to acknowledge receipt of an immediately preceding first number of data bytes after an integer multiple of the first number of data bytes has been transmitted.

In various aspects of the disclosure, an apparatus for managing transactions executed on a serial bus includes means for configuring a slave device coupled to the serial bus with information identifying a first number to be used to count data bytes received from the serial bus, means for initiating a first transaction to transmit a block of data that has a second number of data bytes to the slave device, the second number being greater than the first number, and means for providing an opportunity for the slave device to acknowledge receipt of an immediately preceding first number of data bytes after an integer multiple of the first number of data bytes has been transmitted.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 illustrates certain aspects of the timing relationship between SDA and SCL wires on a conventional I2C bus.

FIG. 5 illustrates timing associated with multiple frames transmitted on an I2C bus.

FIG. 6 illustrates timing related to a command word sent to a slave device in accordance with I2C protocols.

FIG. 7 includes illustrates an example of signaling on a serial bus when the serial bus is operated in a mode of operation defined by I3C specifications.

FIG. 8 illustrates an example of a transmission of a frame in an I3C single data rate mode.

FIG. 9 illustrates an example of a transmission of a frame in an I3C high data rate mode, where data is transmitted at double data rate (DDR).

FIG. 10 illustrates an example of a data block transfer conducted in accordance with certain aspects disclosed herein.

FIG. 11 illustrates a first example of an ACK/NACK opportunity while writing a large block of data in accordance with certain aspects disclosed herein.

FIG. 12 illustrates a first example of a transmission that includes payload data followed in transmission by a dummy byte in accordance with certain aspects of this disclosure.

FIG. 13 illustrates a second example of a transmission that includes payload data followed in transmission by a dummy byte in accordance with certain aspects of this disclosure.

FIG. 14 is a block diagram illustrating an apparatus employing a processing circuit that may be adapted according to certain aspects disclosed herein.

FIG. 15 is a flowchart illustrating certain aspects of method for managing transactions executed on a serial bus in accordance with certain aspects disclosed herein.

FIG. 16 illustrates a hardware implementation for an apparatus adapted that manages transactions executed on a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects and features will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include application-specific IC (ASIC) devices, SoCs and/or other IC devices often employ a shared communication interface that may include a serial bus or other data communication link to connect processors with modems and other peripherals. The serial bus may be operated in accordance with specifications and protocols defined by a standards body. In certain implementations disclosed herein, the serial bus is operated in accordance with protocols such as I2C and/or I3C protocols, which define timing relationships between signals transmitted over the serial bus. Certain aspects disclosed herein relate to systems, apparatus, methods and techniques that provide opportunities for a slave device to report on parity errors before a transaction has been completely transmitted.

Certain aspects of this disclosure relate to managing transactions executed on a serial bus by providing ACK/NACK opportunities before all data in a transaction has been transmitted. In one example, a bus master apparatus includes a bus interface configured to couple the apparatus to a serial bus, and a processor. The processor may configure a slave device coupled to the serial bus with information identifying a first number to be used to count data bytes, initiate a first transaction to transmit a block of data that has a second number of data bytes to the slave device, the second number being greater than the first number, and provide an opportunity for the slave device to acknowledge receipt of an immediately preceding first number of data bytes after an integer multiple of the first number of data bytes has been transmitted In one example, the serial bus is operated in accordance with an I3C protocol.

Example of an Apparatus with a Serial Data Link

According to certain aspects of this disclosure, a serial data link may be employed to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

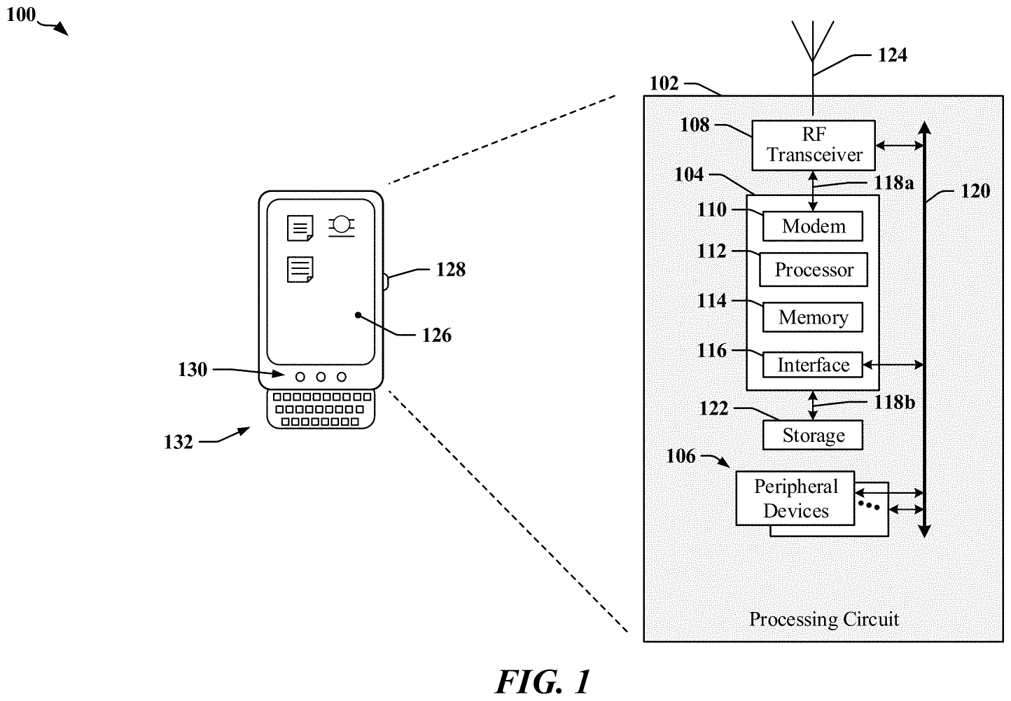

FIG. 1 illustrates an example of an apparatus 100 that employs a data communication bus. The apparatus 100 may include a processing circuit 102 having multiple circuits and/or devices 104, 106 and/or 108, which may be implemented in one or more ASICs or in an SoC for example. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or in other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include non-transitory media, such as read-only memory (ROM), random-access memory (RAM), electrically erasable programmable ROM (EEPROM), flash cards, or other types memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls among other components. The operator controls may include switches or buttons 128, 130 and/or an integrated or external keypad 132. A user interface module may be configured to operate the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In some instances, the bus interface circuit 116 may be configured to operate in accordance with standards-defined communication specifications or protocols. The processing circuit 102 may include or control a power management function that configures and manages the operation of the apparatus 100.

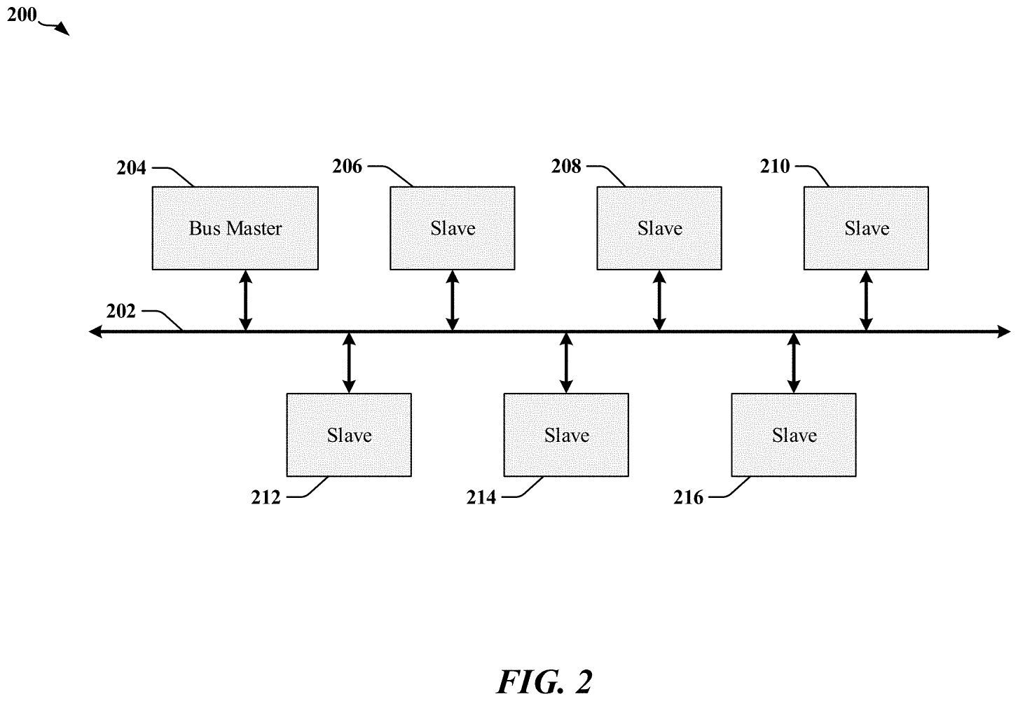

FIG. 2 illustrates a communication link 200 in which multiple devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols that define signaling state of clock and data signals, where timing information is embedded in the transmission of the symbols.

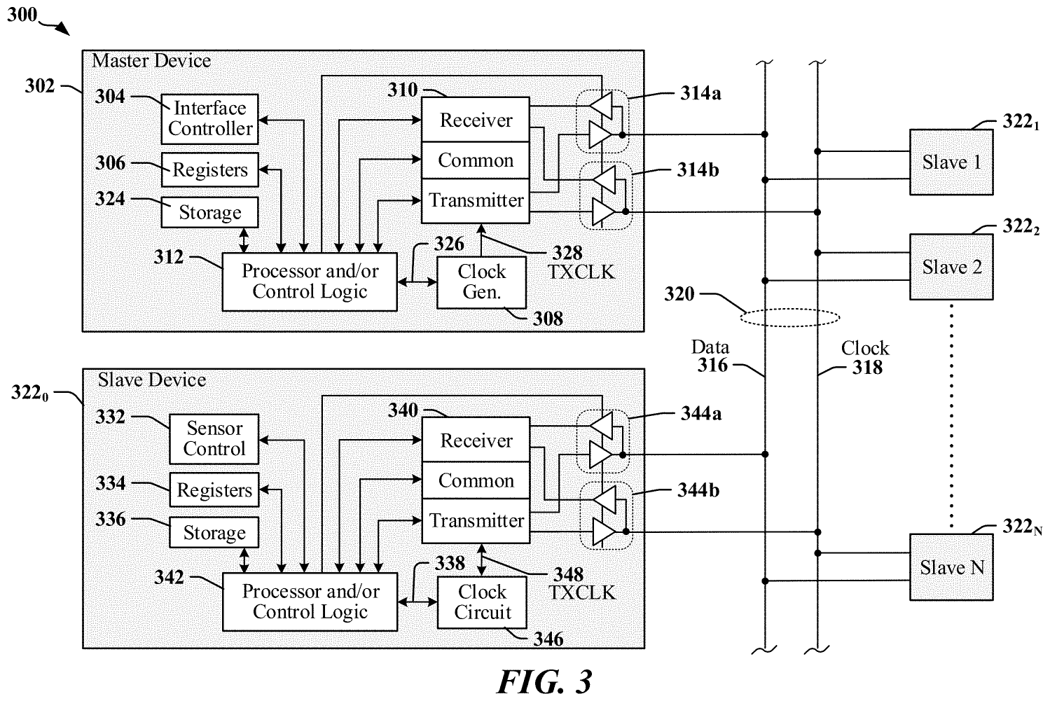

FIG. 3 illustrates certain aspects of an apparatus 300 that includes multiple devices 302, and 322₀-322_{N} coupled to a serial bus 320. The devices 302 and 322₀-322_{N} may be provided in one or more semiconductor IC devices, such as an application processor, SoC or ASIC. In various implementations, the devices 302 and 322₀-322_{N} can include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communication between devices 302 and 322₀-322_{N} over the serial bus 320 is controlled by a bus master device 302. Certain types of bus can support multiple bus master devices 302.

In one implementation, a bus master device 302 includes an interface controller 304 that manages access to the serial bus, configures dynamic addresses for slave devices 322o-322_{N} and/or generates a clock signal 328 to be transmitted on a clock line 318 of the serial bus 320. The bus master device 302 may include configuration registers 306 or other storage 324, and/or control logic 312 configured to handle protocols or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic circuits and/or storage devices. In one example, the transmitter encodes and transmits data based on timing in the clock signal 328 provided by a clock generation circuit 308. Other timing clock signals 326 may be provided for the use of the control logic 312 and other functions, circuits or modules.

At least one device 322₀-322_{N} can be configured to operate as a slave device on the serial bus 320 and may include circuits and modules that support a display, an image sensor, and/or circuits and modules that control and communicate with one or more sensors that measure environmental conditions. In one example, a slave device 322o configured to operate as a slave device may provide a control function, module or circuit 332 that includes circuits and modules to support a display, an image sensor, and/or circuits and modules that control and communicate with one or more sensors that measure environmental conditions. The slave device 322o may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic circuits and/or storage devices. In one example, the transmitter encodes and transmits data based on timing in a clock signal 348 provided by clock generation and/or recovery circuits 346. The clock signal 348 may be derived from a signal received from the clock line 318. Other timing clock signals 338 may be provided for the use of the control logic 342 and other functions, circuits or modules.

The serial bus 320 may be operated in accordance with an I2C, I3C, RFFE, SPMI, or other protocol. At least one device 302, 322₀-322_{N} may be configured to operate as a master device and a slave device on the serial bus 320. Two or more devices 302, 322o-322_{N} may be configured to operate as a master device on the serial bus 320.

In one example, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

### Data Transfers Over a Serial Bus

Data transfers using I2C and I3C protocols to control signaling, command and payload transmissions are illustrated by way of example. However, certain concepts disclosed herein are applicable to other bus configurations and protocols, including RFFE and SPMI configurations and protocols. In one example, data may be transferred in accordance with an I3C HDR protocol that encodes data in ternary symbols (HDR-TSP), and HDR-TSP timeslots may be defined in terms of HDR-TSP words, where each slot may be expressed as a set of six successive recovered clock pulses, which is the equivalent number of clock pulses for an HDR-TSP word. In another example, data may be transferred in accordance with an I3C HDR double data rate (HDR-DDR) protocol, where timeslots may be defined in terms of HDR-DDR words and/or expressed as the number of clock pulses used to transmit an HDR-DDR word. The concepts disclosed herein may be applicable to a serial bus operated in accordance with a protocol that supports multiple data lanes.

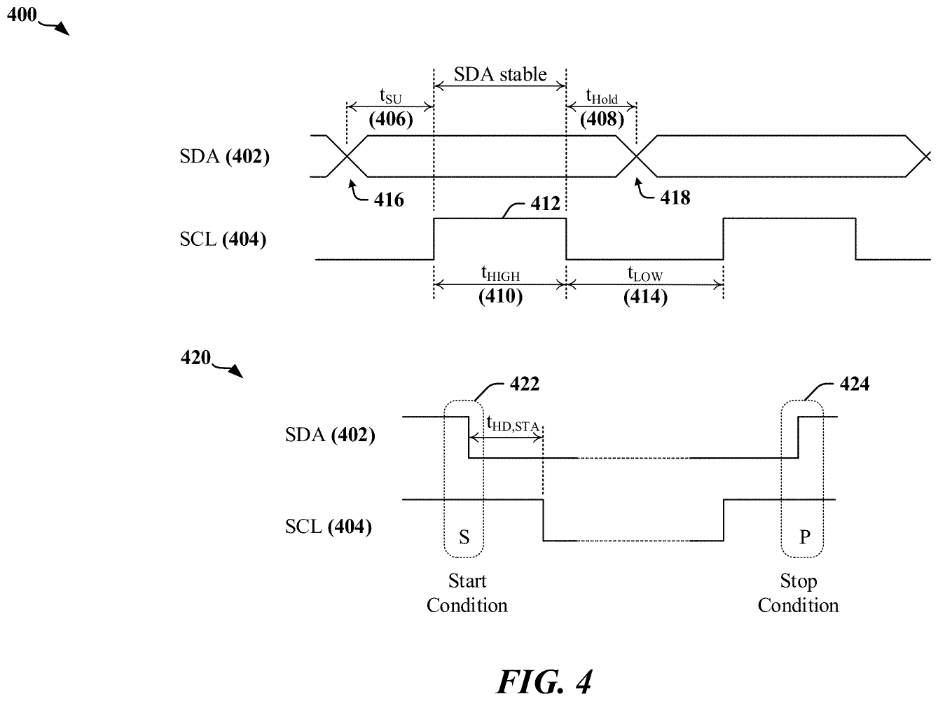

FIG. 4 includes timing diagrams 400 and 420 that illustrate the relationship between the SDA wire 402 and the SCL wire 404 of a serial bus operated in certain I2C and I3C modes. The first timing diagram 400 illustrates the timing relationship between the SDA wire 402 and the SCL wire 404 while data is being transferred on a conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid, such that the state of the SDA wire 402 is not permitted to change when the SCL wire 404 is in the high logic state.

In one example, specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for data setup time 406 (t_{SU}) before occurrence of the pulse 412, and data hold time 408 (t_{Hold}) after the pulse 412 terminates. The signaling state of the SDA wire 402 is expected to be stable during the setup time 406 and the hold time 408. The setup time 406 defines a maximum duration of time after a transition 416 between signaling states on the SDA wire 402 until the arrival of the rising edge of the pulse 412 on the SCL wire 404. The hold time 408 defines a minimum duration of time after the falling edge of the pulse 412 on the SCL wire 404 until a next transition 418 between signaling states on the SDA wire 402. The I2C Specifications also define a minimum duration 414 for a low period (t_{Low}) for the SCL wire 404. The data on the SDA wire 402 is typically stable and/or can be captured for the duration 410 (t_{HIGH}) when the SCL wire 404 is in the high logic state after the leading edge of the pulse 412.

Certain protocols provide for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

The second timing diagram 420 of FIG. 4 illustrates signaling states on the SDA wire 402 and the SCL wire 404 between data transmissions on a serial bus. A start condition 422 is defined to permit the current bus master to signal that data is to be transmitted. The start condition 422 occurs when the SDA wire 402 transitions from high to low while the SCL wire 404 is high. The bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed slave device, if available, responds with an ACK bit. If no slave device responds, the bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a stop condition 424 is transmitted by the master device. The stop condition 424 occurs when the SDA wire 402 transitions from low to high while the SCL wire 404 is high.

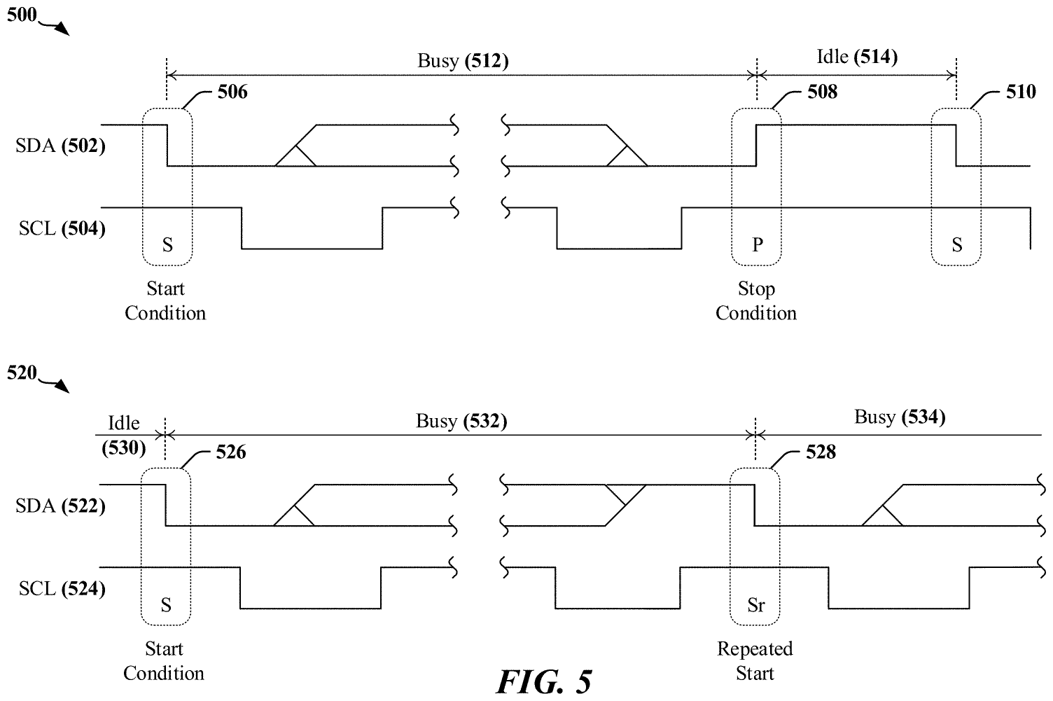

FIG. 5 includes diagrams 500 and 520 that illustrate timing associated with data transmissions on a serial bus operated in accordance with an I2C or I3C protocol. As illustrated in the first diagram 500, an idle period 514 may occur between a stop condition 508 and a consecutive start condition 510. In the illustrated example, the SDA line 502 and SCL line 504 may be held and/or driven to a high voltage state during the idle period 514. This idle period 514 may be prolonged, and may result in reduced data throughput when the serial bus remains idle between the stop condition 508 and the next start condition 510. In operation, a busy period 512 commences when the I2C bus master transmits a first start condition 506, followed by data. The busy period 512 ends when the bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

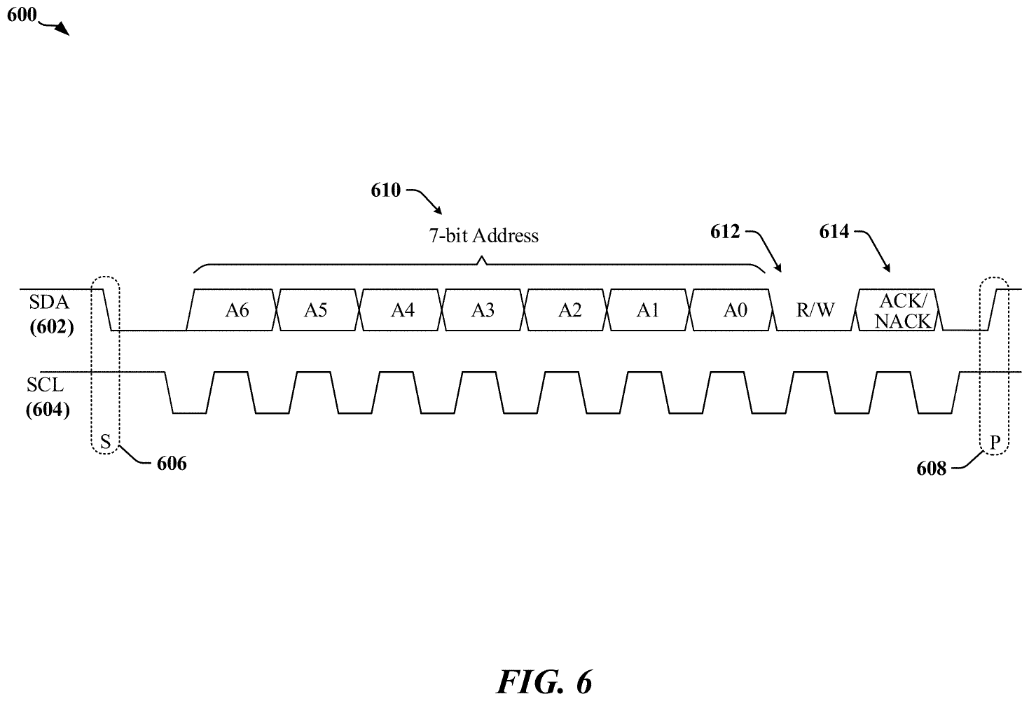

FIG. 6 illustrates an example of the timing 600 associated with an address word sent to a slave device in accordance with certain I2C and/or I3C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an ACK by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the serial bus is in an active state.

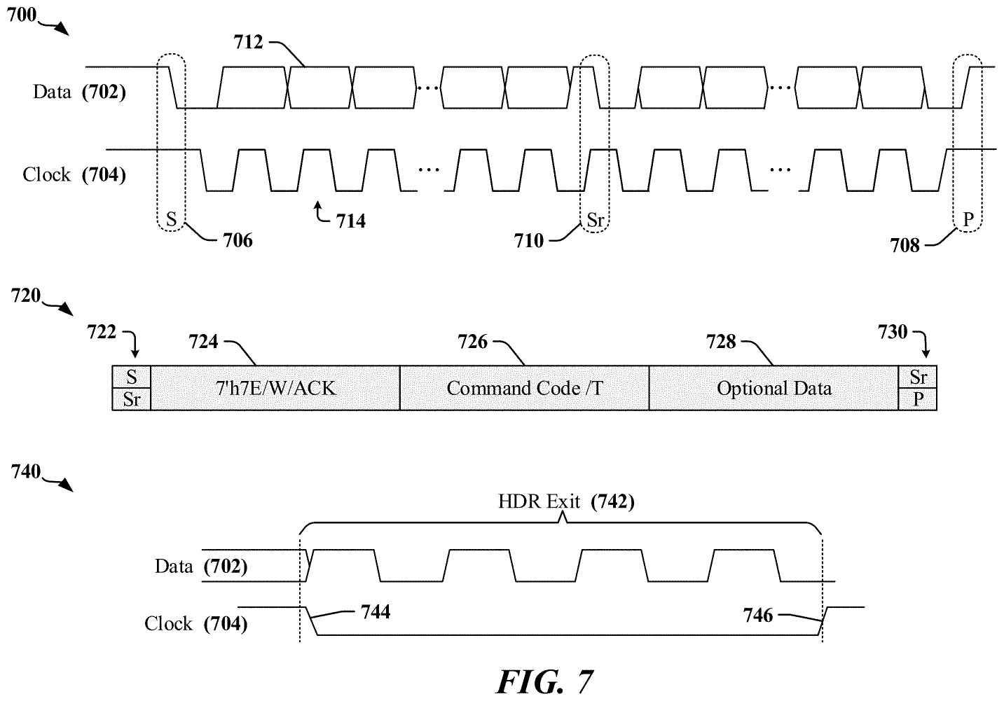

FIG. 7 illustrates signaling 700 on a serial bus when the serial bus is operated in a single data rate (SDR) mode of operation defined by I3C specifications. Data transmitted on a first wire of the serial bus, which may be referred to as the Data wire 702, SDA or SDATA, may be captured using a clock signal transmitted on a second wire of the serial bus, which may be referred to as the Clock wire 704, SCL or SCLOCK. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a START condition 706, a STOP condition 708 or a Repeated Start 710.

On an I3C serial bus, a START condition 706 is defined to permit the current bus master to signal that data is to be transmitted. The START condition 706 occurs when the Data wire 702 transitions from high to low while the Clock wire 704 is high. The bus master may signal completion and/or termination of a transmission using a STOP condition 708. The STOP condition 708 is indicated when the Data wire 702 transitions from low to high while the Clock wire 704 is high. A Repeated Start 710 may be transmitted by a bus master that wishes to initiate a second transmission upon completion of a first transmission. The Repeated Start 710 is transmitted instead of a STOP condition 708, and has the significance of a STOP condition 708 followed immediately by a START condition 706. The Repeated Start 710 occurs when the Data wire 702 transitions from high to low while the Clock wire 704 is high.

The bus master may transmit an initiator 722 that may be a START condition 706 or a Repeated Start 710 prior to transmitting an address of a slave, a command, and/or data. FIG. 7 illustrates a command code transmission 720 by the bus master. The initiator 722 may be followed in transmission by a predefined address header 724 and a command code 726. The command code 726 may, for example, cause the serial bus to transition to a desired mode of operation. In some instances, data 728 may be transmitted. The command code transmission 720 may be followed by a terminator 730 that may be a STOP condition 708 or a Repeated Start 710.

Certain serial bus interfaces support signaling schemes that provide higher data rates. In one example, I3C specifications define multiple HDR modes, including the HDR-DDR mode in which data is transferred at both the rising edge and the falling edge of the clock signal.

An I3C bus may be switched between SDR and DDR modes. FIG. 7 includes an example of signaling 740 transmitted on the Data wire 702 and the Clock wire 704 to initiate certain mode changes. The signaling 740 is defined by I3C protocols for use in initiating restart, exit and/or break from I3C HDR modes of communication. The signaling 740 includes an HDR Exit 742 that may be used to cause an HDR break or exit. The HDR Exit 742 commences with a falling edge 744 on the Clock wire 704 and ends with a rising edge 746 on the Clock wire 704. While the Clock wire 704 is in a low signaling state, four pulses are transmitted on the Data wire 702. I2C devices ignore the Data wire 702 when no pulses are provided on the Clock wire 704.

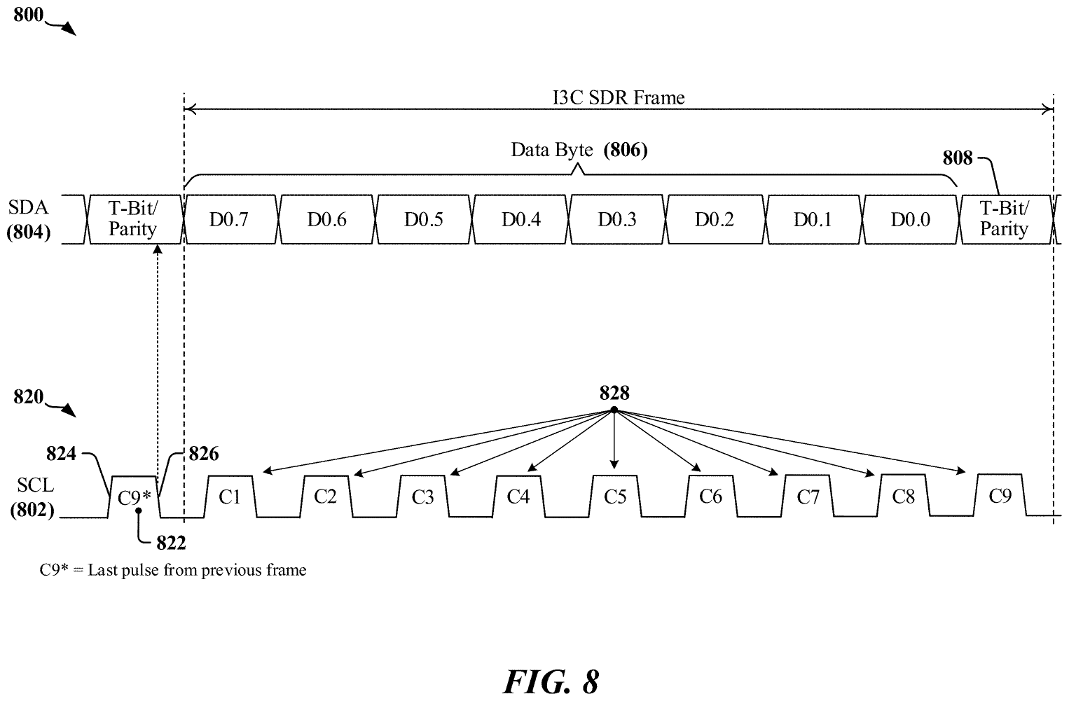

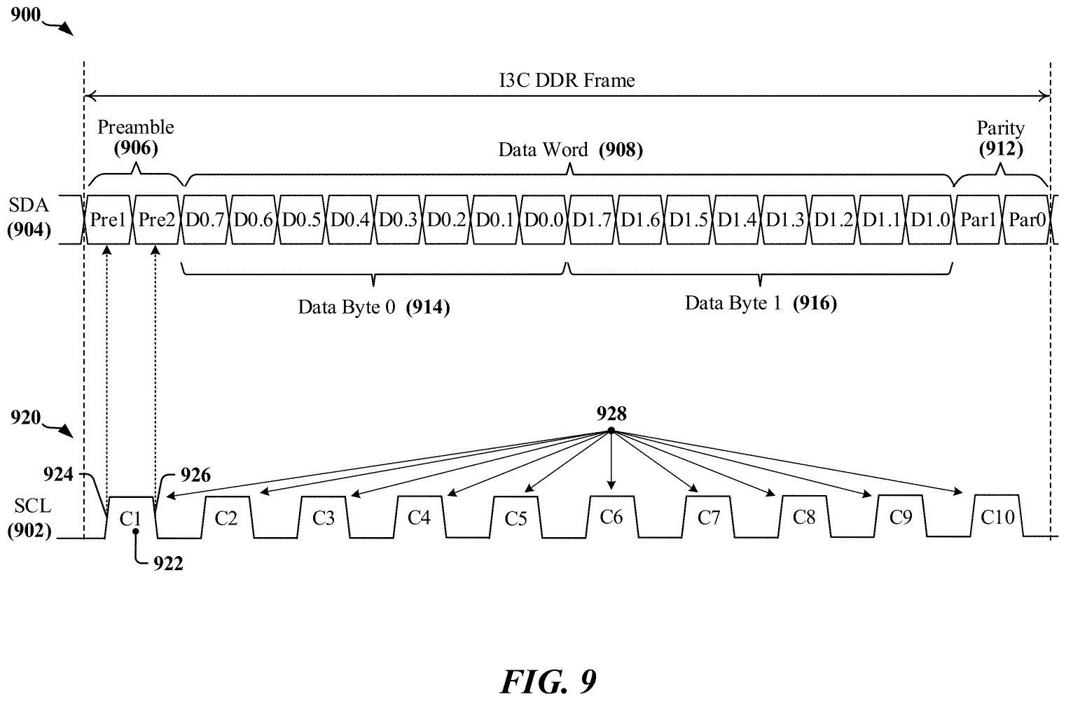

FIGS. 8 and 9 include timing diagrams that illustrate frames 800, 900 transmitted on a serial bus when a bus master device is reading from a slave device. The serial bus has a clock wire (SCL 802, 902) and a Data wire (SDA 804, 904). A clock signal 820, 920 transmitted on SCL 802, 902 provides timing information that can be used when the serial bus is operated in an I3C single data rate (SDR) mode and in an I3C HDR-DDR mode. The clock signal includes pulses 822, 828, 922, 928 that are defined by a rising edge 824, 924 and a falling edge 826, 926. A bus master device transmits the clock signal on the SCL 802, 902 regardless of the direction of flow of data over the serial bus.

FIG. 8 illustrates a frame 800 transmitted while the serial bus is operated in the I3C SDR mode. A single byte of data 806 is transmitted in each frame 800. The data signal transmitted on SDA 804 is expected to be stable for the duration of the high state of the pulses 828 in the clock signal 820 and, in one example, the state of SDA 804 is sampled on the falling edges of the clock pulses 828. Each byte of data 806 is followed by a bit 808 that can serve as a parity bit or a transition bit (T-Bit).

FIG. 9 illustrates a frame 900 transmitted while the serial bus is operated in the HDR-DDR mode. In the HDR-DDR mode, data is transferred at both the rising edge 924 and the falling edge 926 of a pulse 922 in the clock signal 920. A receiver samples or captures one bit of data on SDA 904 at each edge of the pulses 928 in the clock signal 920. A 2-byte data word 908 is transmitted in each frame 900 in the HDR-DDR mode. A data word 908 generally includes 16 payload bits, organized as two 8-bit bytes 914, 916 and the data word 908 is preceded by a two-bit preamble 906 and followed by two parity bits 912. The 20 bits in the frame 900 can be transferred on the edges of 10 clock pulses. The integrity of the transmission may be protected by the transmission of the parity bits 912.

### Parity Checking on a Serial Bus

In conventional I2C transmissions, the ninth bit in a data frame transmitted during a slave write transaction is an ACK/NACK bit that is driven by the slave device addressed by the write transaction. As illustrated in FIG. 8, the ninth bit 808 in a data frame transmitted to a slave device in an I3C SDR transaction serves as a transition bit (T-Bit) or parity bit for the preceding 8-bit byte of data 806. According to I3C protocols, the slave device does not have an opportunity to acknowledge receipt of data until the end of the transaction. The inability to acknowledge receipt of data also includes an inability to send a negative acknowledgement to indicate a parity error.

The inability of a slave device to indicate detections of parity errors during slave write operations can reduce the efficiency of the serial bus and devices coupled to the serial bus, due to the time lost between parity error detection by the slave device and parity error reporting to the transmitting device by the slave device. In some implementations, large blocks of data may be transferred to the slave device for writing to Flash memory. In one example, blocks of data including firmware may be transferred to a slave device to be written to a Flash memory device. The occurrence of a parity error near the beginning of the transaction may be notified only at the termination of the transaction, which may result in a time-consuming and inefficient Flash writing operation and, in some instances, repeated writes to the Flash memory.

According to certain aspects disclosed herein, a master device may provide an opportunity for slave devices to provide an ACK or NACK during a slave write transaction after a preconfigured number of bytes have been transmitted. The master device may configure the number of bytes that can be transmitted before an ACK/NACK opportunity is provided.

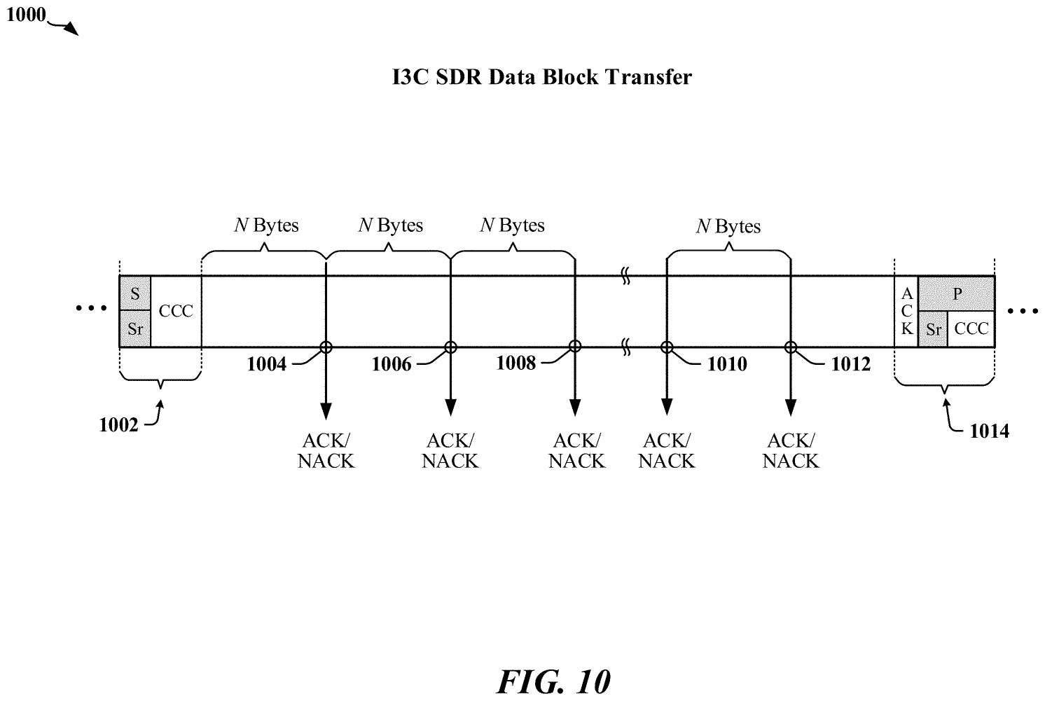

FIG. 10 illustrates an example of a data block transfer 1000 transaction conducted in accordance with certain aspects disclosed herein. In the illustrated example, a bus master device transmits data to a slave device in accordance with an I3C SDR protocol. The transfer commences with initiating signaling 1002 that may include a START condition (S) or Repeated Start (Sr). The initiating signaling 1002 may also include one or more commands or codes, such as a CCC that initiates a write of the data to one or more slave devices. The transfer is terminated by signaling 1014 that includes an ACK/NACK, and a STOP condition or a Repeated Start (Sr) followed by a CCC.

According to certain aspects of this disclosure, the bus master device may provide ACK/NACK opportunities 1004, 1006, 1008, 1010, 1012 during a transmission of a block of data to the slave device and before the block of data has been completely transmitted. The ACK/NACK opportunities 1004, 1006, 1008, 1010, 1012 may be provided after every Nth byte has been transmitted. The bus master device may configure the value of N at the slave device. The value of N may be determined by the bus master device, by an application, during system configuration and/or during device manufacture.

I3C protocols define no limit to the maximum message length transmitted using transactions initiated by certain CCCs. The maximum length can be defined by negotiation between the bus master device and the slave device. The maximum length may be configured to minimize or optimize latency while providing a minimum desired serial bus throughput under optimal or nominal bus operating conditions. The ability of a bus interface to provide optimized latency and a desired throughput may be compromised by parity errors that occur during transfer of large blocks of data when the serial bus is subject to less than ideal operating conditions. For example, a slave device cannot report a parity error detected in a 4 kilobyte block transfer until the entire 4 kilobyte block has been completely transmitted. In this example, calculation of the maximum bus latency expected when parity errors are frequent may include a consideration of the time required to retransmit at least one block of 4 kilobytes.

In the example of a 4 kilobyte block transfer, a slave device adapted in accordance with certain aspects of this disclosure may be provided ACK/NACK opportunities 1004, 1006, 1008, 1010, 1012 after each set of N=64 bytes have been transmitted. Other values of N can be defined based on the size of the data block transferred, to ensure a desired maximum bus latency and/or to obtain a minimum throughput under observed or expected serial bus conditions. The bus master device may configure the slave device with information defining the frequency of occurrence and/or location in the transaction of the ACK/NACK opportunities 1004, 1006, 1008, 1010, 1012. A slave device may be configured to drive the serial bus during an ACK/NACK opportunity 1004, 1006, 1008, 1010, 1012 to acknowledge the preceding N bytes. If a slave device does not acknowledge the preceding N bytes during an ACK/NACK opportunity 1004, 1006, 1008, 1010, 1012, the bus master device may choose to terminate the current transaction and retransmit the unacknowledged data immediately. Retransmitting the N bytes can improve bus throughput and/or efficiency with respect to conventional systems that wait until the transaction has been completed before retransmitting the entire data block.

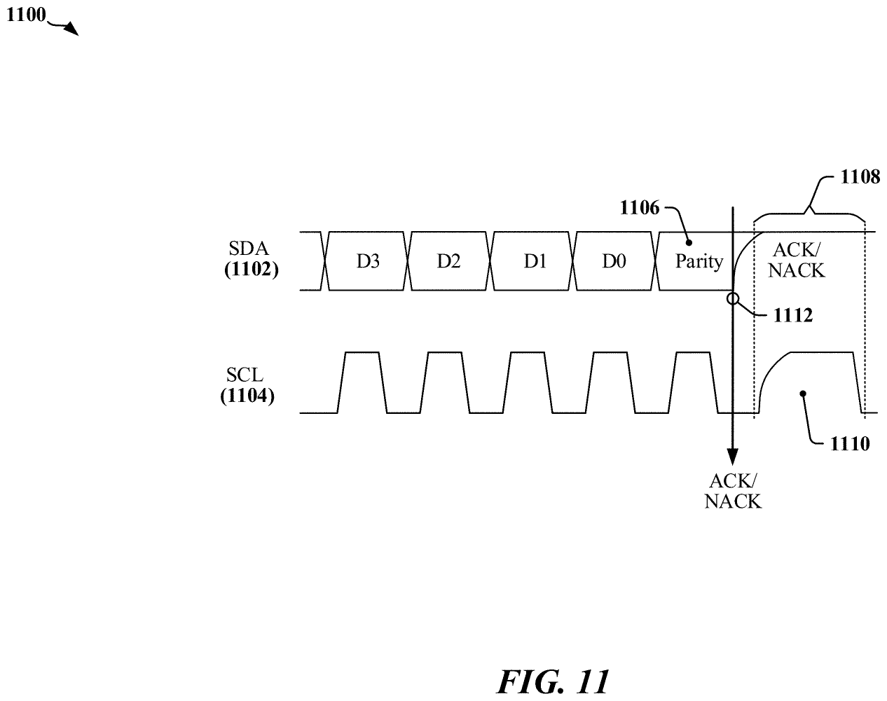

FIG. 11 illustrates timing 1100 of a first example of an ACK/NACK opportunity 1004, 1006, 1008, 1010, 1012 provided in accordance with certain aspects of this disclosure. In certain implementations, the ACK/NACK opportunity 1004, 1006, 1008, 1010, 1012 is provided during a write operation involving a large block of data. The ACK/NACK opportunity 1004, 1006, 1008, 1010, 1012 is provided when the bus master device causes its line driver coupled to the SDA line 1102 to enter a high-impedance state at a time 1112 occurring while or after the parity bit 1106 is being transmitted. The SDA line 1102 may then be pulled up by a resistor that is configured to couple the SDA line 1102 to a high voltage rail. By entering the high-impedance state, the bus master device effectively causes its line driver to comply with open-drain mode in a manner defined by I3C protocols. By entering the high-impedance state, the bus master provides an ACK/NACK opportunity 1108 that permits a slave device to drive the SDA line 1102. In one example, the slave device may drive the SDA line 1102 low to signal an ACK that indicates that the slave device detected no parity error in the preceding N bytes. In another example, the slave device may refrain from driving the SDA line 1102, which remains high because of the pullup resistor, and the high state of the SDA line 1102 is interpreted by the bus master device as a NACK, indicating that the slave device detected a parity error in the preceding N bytes.

In some instances, the bus master device may stretch the clock signal transmitted on the SCL line 1104 to provide a longer bit transmission interval to allow the parity bit 1106 to be transmitted and to permit sufficient time for an ACK transmission. In some instances, and as illustrated in FIG. 11, an extra clock pulse 1110 is provided. The extra clock pulse 1110 may be actively driven by the bus master device. In some implementations, the extra clock pulse 1110 may be provided when the bus master device causes its line driver coupled to the SCL line 1104 to enter high-impedance state before actively driving the SCL line 1104 low to signal the end of the ACK/NACK opportunity 1108. When the line driver coupled to the SCL line 1104 is in the high-impedance state, the SCL line 1104 may be pulled up by a resistor. The extra clock pulse 1110 may provide timing information that enables the slave device to drive an ACK on the SDA line 1102.

In some implementations, the bus master device may provide the ACK/NACK opportunities 1004, 1006, 1008, 1010, 1012 by transmitting a dummy byte. The dummy byte may be inserted after every Nth byte of a transaction payload has been transmitted. Each data byte of the transaction payload includes 8 data bits and one parity bit transmitted in nine clock cycles. The dummy byte may also have nine bits transmitted in nine clock cycles, where the ninth bit is an ACK/NACK bit. The ACK/NACK bit is provided when the master device releases the SDA line. The master device may release the SDA line by causing an output of its line driver to enter a high-impedance state. A slave device may drive the SDA line low during the ninth bit in order to acknowledge the preceding N data bytes. In some instances, the bus master device may reconfigure or renegotiate the maximum message length to accommodate the insertion of dummy bytes.

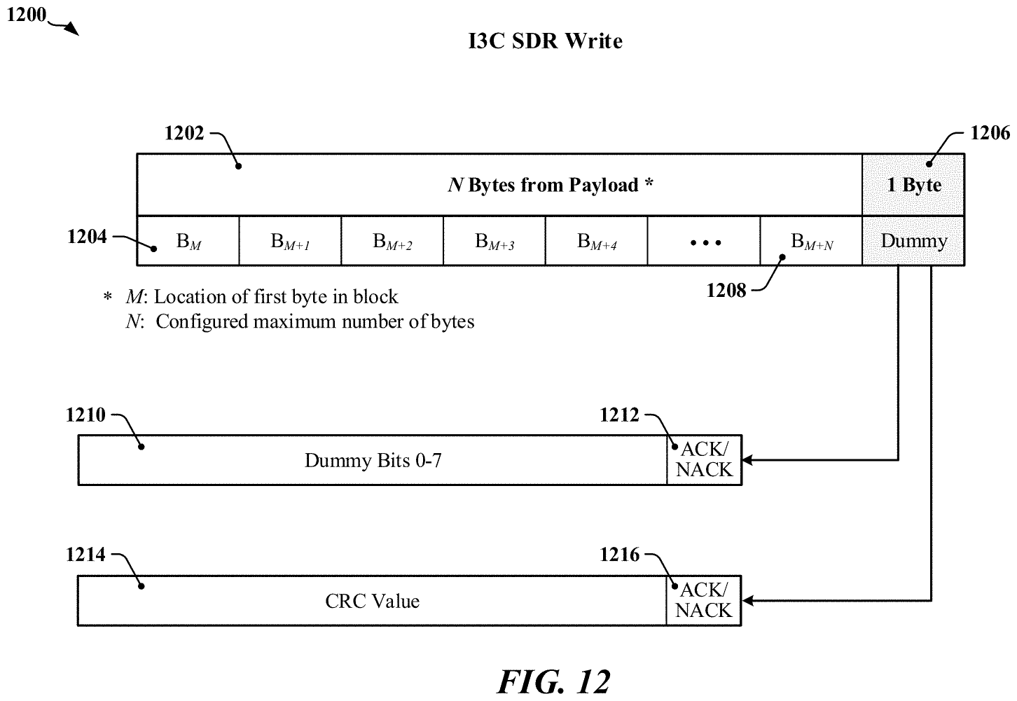

FIG. 12 illustrates a first example of a transmission 1200 that includes N bytes of payload data 1202 followed in transmission by a dummy byte 1206 in accordance with certain aspects of this disclosure. The transmission 1200 may be part of a slave write transaction executed by a bus master device, for example. The first-transmitted byte 1204 may be the Mth byte in a block of data transmitted in the slave write transaction, and the dummy byte 1206 is transmitted after the (M+N)th byte 1208 in the block of data, in the case where the dummy byte 1206 is transmitted after every Nth byte of transaction payload data has been transmitted.

Each byte of the transaction payload data includes 8 data bits and one parity bit, and the dummy byte 1206 may be transmitted using nine bit-transmission intervals. In one example, the bus master device transmits 8 data bits and a provides a transmission interval for a ninth bit 1212, 1216 that serves as the ACK/NACK bit for the preceding N data bytes. The master device releases the SDA line during the transmission interval for the ninth bit 1212, 1216. The master device may release the SDA line by causing the output of a line driver to enter a high impedance state, and to permit a slave device to drive the SDA line low in order to acknowledge the preceding N data bytes.

The dummy byte 1206 can have multiple configurations. In a first configuration, the bus master device transmits 8 dummy data bits 1210 and provides the transmission interval for the ninth bit 1212 to serve as the ACK/NACK bit for the preceding N data bytes. The dummy data bits 1210 may be set to any value or combination of values. In one example, the dummy data bits 1210 may have the same value. In another example, the dummy data bits 1210 may repeat a previously transmitted value. In another example, the dummy data bits 1210 may represent a randomly selected or preconfigured value. In a second configuration, the bus master device transmits a CRC value 1214 calculated over at least the preceding N data bytes, and provides the transmission interval for the ninth bit 1216 to serve as the ACK/NACK bit for the preceding N data bytes. In some instances, the CRC value 1214 may be provided as an 8-bit code. In other instances, the CRC value 1214 may be provided using fewer than 8 bits. In some implementations, the CRC value 1214 is calculated over the preceding N data bytes. In other implementations, the CRC value 1214 is calculated over all preceding bytes (M+N bytes) in the transaction, and the CRC value 1214 may be an intermediate value obtained from CRC logic configured to provide a CRC code for the complete transaction. The CRC value 1214 may be provided when multiple parity errors are possible or expected. Multiple parity errors can cause double bit-flips that nullify one-bit parity error detections.

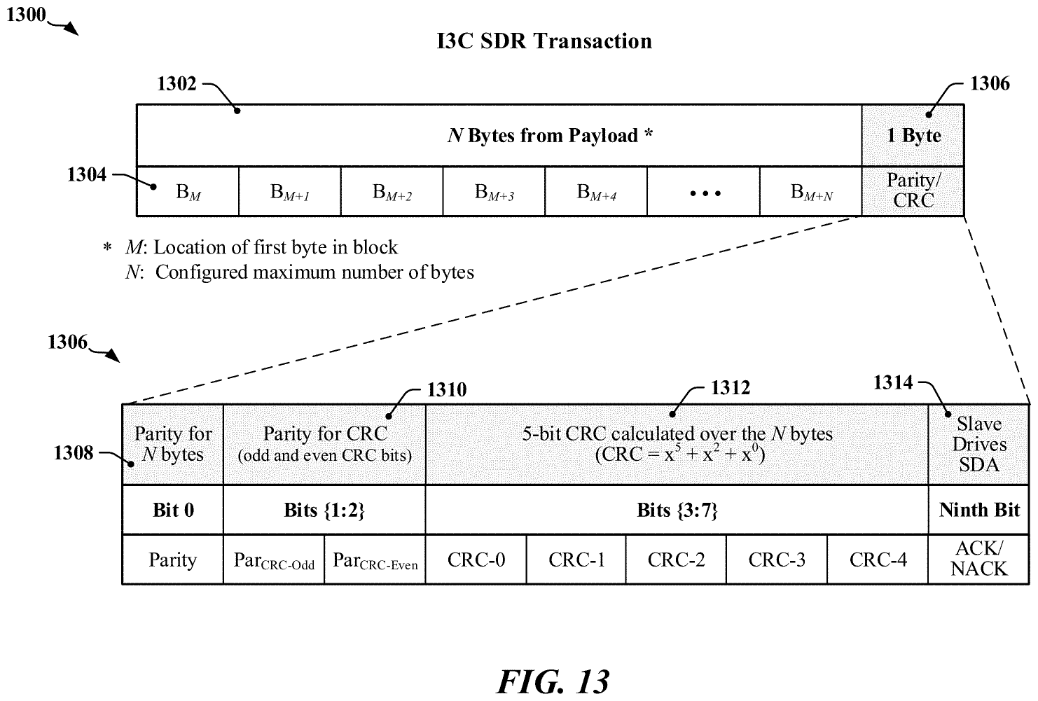

FIG. 13 illustrates a second example of a transmission 1300 that includes N bytes of payload data 1302 followed in transmission by an error detection byte 1306 in accordance with certain aspects of this disclosure. The transmission 1300 may be part of a slave write transaction executed by a bus master device, for example. The first-transmitted byte 1304 may be the Mth byte in a block of data transmitted in the slave write transaction and the error detection byte 1306 may be transmitted after the (M+N)th byte in the block of data, when the error detection byte 1306 is transmitted after every Nth byte of transaction payload data has been transmitted.

Each byte of the transaction payload data includes 8 data bits and one parity bit. The error detection byte 1306 may be transmitted as 8 data bits followed by one bit provided to serve as the ACK/NACK bit for the preceding N data bytes. The master device releases the SDA line during the transmission interval for the ninth bit 1314. The master device may release the SDA line by causing the output of a line driver to enter a high-impedance state, and to permit a slave device to drive the SDA line low in order to acknowledge the preceding N data bytes.

One configuration of the error detection byte 1306 is illustrated, in which the bus master device transmits a CRC code 1312 that may supplement or supplant the parity checking mechanism provided by the parity bits transmitted with each data byte. The transmission interval for the ninth bit 1314 may serve as the ACK/NACK bit for the preceding N data bytes. The CRC code 1312 may be calculated over at least the preceding N data bytes. The CRC code 1312 may be provided as a 5-bit value. In some implementations, the CRC code 1312 may be calculated using an algorithm defined by the MIPI Alliance. For example, the CRC code 1312 may be calculated using an algorithm defined by I3C HDR-DDR protocols: CRC code=x⁵+x²+x⁰. Devices that are configured for I3C operations may include hardware, software or some combination of hardware and software that implements the I3C HDR-DDR CRC algorithm. Other CRC algorithms may be used. In some instances, the length of the CRC code 1312 may be defined or configured by application.

The error detection byte 1306 may include one or more parity bits for the preceding N data bytes, and/or one or more parity bits 1308, 1310 for the CRC code 1312. In the example illustrated in FIG. 13, one parity bit 1308 provides a parity check for the preceding N data bytes and two parity bits 1310 provide parity for the CRC code 1312. In some instances, the parity bits 1310 include a one-bit parity check for the odd bits in the CRC code 1312 and a one-bit parity check for the even bits in the CRC code 1312. The parity bits 1308, 1310 for the CRC code 1312 may provide a mechanism to check that the CRC code 1312 was received without error.

In some implementations, the CRC code 1312 is calculated over the preceding N data bytes. In other implementations, the CRC value 1214 is calculated over all preceding bytes (M+N bytes) in the transaction, and the CRC code 1312 may be an intermediate value obtained from CRC logic configured to provide a CRC value for the complete transaction. The CRC code 1312 may be provided when multiple parity errors are possible or expected. Multiple parity errors can cause double bit-flips that nullify parity error detections.

The number of data bytes (N) transmitted before insertion of the error detection byte 1306 may be determined based on the type of error detection used, the length of the transaction and the noise level experienced by the serial bus. Transmission of the error detection byte 1306 may enable the bus master device to quickly detect transmission errors, terminate the current transaction and retransmit the erroneously-received data without significantly increasing transmission overhead. For example, the insertion of an error detection byte 1306 after each transmission of 64 bytes of data may be more efficient than conventional error detection schemes when retransmissions of erroneously-received data involve 64 bytes in a system configured according to certain aspects of this disclosure, rather than retransmissions of the entire 4 kilobytes.

While the examples disclosed herein relate to I3C SDR modes of communication, certain aspects disclosed herein may apply equally to I3C DDR modes of communication. Moreover, the concepts, systems, methods and techniques described herein may be applied to a serial bus operated using other serial protocols.

### Examples of Processing Circuits and Methods

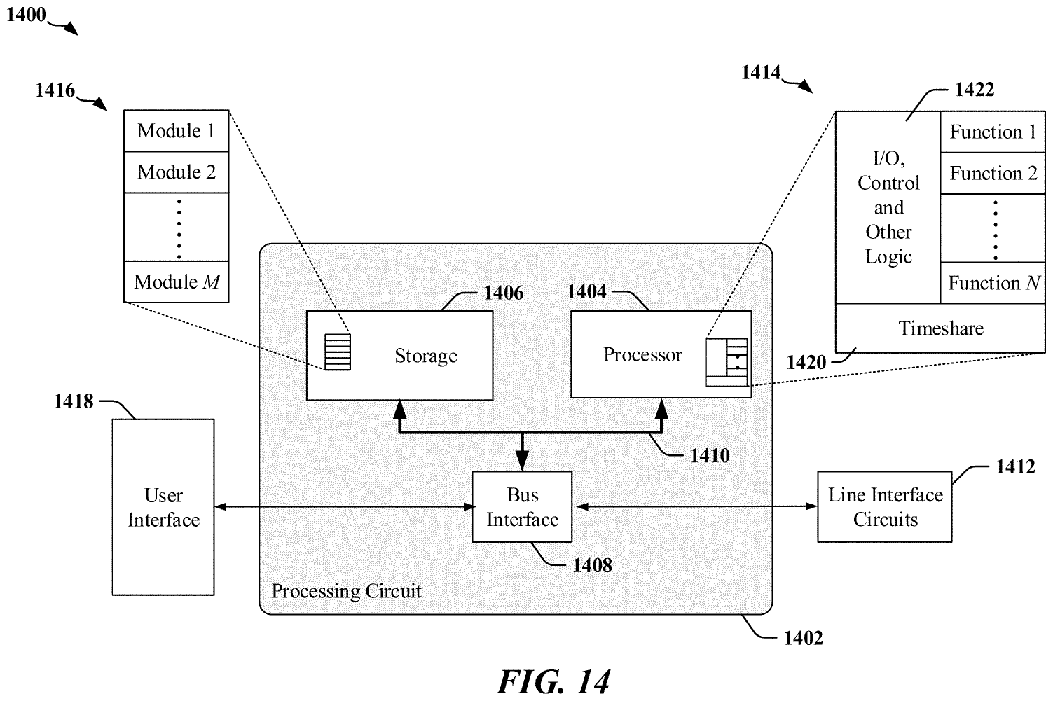

FIG. 14 is a diagram illustrating an example of a hardware implementation for an apparatus 1400 employing a processing circuit 1402 that may be configured to perform one or more functions disclosed herein. In accordance with various aspects of the disclosure, an element, or any portion of an element, or any combination of elements as disclosed herein may be implemented using the processing circuit 1402. The processing circuit 1402 may include one or more processors 1404 that are controlled by some combination of hardware and software modules. Examples of processors 1404 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1404 may include specialized processors that perform specific functions, and that may be configured, augmented or controlled by one of the software modules 1416. The one or more processors 1404 may be configured through a combination of software modules 1416 loaded during initialization, and further configured by loading or unloading one or more software modules 1416 during operation. In various examples, the processing circuit 1402 may be implemented using a state machine, sequencer, signal processor and/or general-purpose processor, or a combination of such devices and circuits.

In the illustrated example, the processing circuit 1402 may be implemented with a bus architecture, represented generally by the bus 1410. The bus 1410 may include any number of interconnecting buses and bridges depending on the specific application of the processing circuit 1402 and the overall design constraints. The bus 1410 links together various circuits including the one or more processors 1404, and storage 1406. Storage 1406 may include memory devices and mass storage devices, and may be referred to herein as computer-readable media and/or processor-readable media. The bus 1410 may also link various other circuits such as timing sources, timers, peripherals, voltage regulators, and power management circuits. A bus interface 1408 may provide an interface between the bus 1410 and one or more transceivers 1412. A transceiver 1412 may be provided for each networking technology supported by the processing circuit 1402. In some instances, multiple networking technologies may share some or all of the circuitry or processing modules found in a transceiver 1412. Each transceiver 1412 provides a means for communicating with various other apparatus over a transmission medium. Depending upon the nature of the apparatus 1400, a user interface 1418 (e.g., keypad, display, speaker, microphone, joystick) may also be provided, and may be communicatively coupled to the bus 1410 directly or through the bus interface 1408.

A processor 1404 may be responsible for managing the bus 1410 and for general processing that may include the execution of software stored in a computer-readable medium that may include the storage 1406. In this respect, the processing circuit 1402, including the processor 1404, may be used to implement any of the methods, functions and techniques disclosed herein. The storage 1406 may be used for storing data that is manipulated by the processor 1404 when executing software, and the software may be configured to implement any one of the methods disclosed herein.

One or more processors 1404 in the processing circuit 1402 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1406 or in an external computer-readable medium. The external computer-readable medium and/or storage 1406 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1406 may also include, by way of example, a carrier wave, a transmission line, and any other suitable medium for transmitting software and/or instructions that may be accessed and read by a computer. Computer-readable medium and/or the storage 1406 may reside in the processing circuit 1402, in the processor 1404, external to the processing circuit 1402, or be distributed across multiple entities including the processing circuit 1402. The computer-readable medium and/or storage 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1406 may maintain software maintained and/or organized in loadable code segments, modules, applications, programs, etc., which may be referred to herein as software modules 1416. Each of the software modules 1416 may include instructions and data that, when installed or loaded on the processing circuit 1402 and executed by the one or more processors 1404, contribute to a run-time image 1414 that controls the operation of the one or more processors 1404. When executed, certain instructions may cause the processing circuit 1402 to perform functions in accordance with certain methods, algorithms and processes described herein.

Some of the software modules 1416 may be loaded during initialization of the processing circuit 1402, and these software modules 1416 may configure the processing circuit 1402 to enable performance of the various functions disclosed herein. For example, some software modules 1416 may configure internal devices and/or logic circuits 1422 of the processor 1404, and may manage access to external devices such as the transceiver 1412, the bus interface 1408, the user interface 1418, timers, mathematical coprocessors, and so on. The software modules 1416 may include a control program and/or an operating system that interacts with interrupt handlers and device drivers, and that controls access to various resources provided by the processing circuit 1402. The resources may include memory, processing time, access to the transceiver 1412, the user interface 1418, and so on.

One or more processors 1404 of the processing circuit 1402 may be multifunctional, whereby some of the software modules 1416 are loaded and configured to perform different functions or different instances of the same function. The one or more processors 1404 may additionally be adapted to manage background tasks initiated in response to inputs from the user interface 1418, the transceiver 1412, and device drivers, for example. To support the performance of multiple functions, the one or more processors 1404 may be configured to provide a multitasking environment, whereby each of a plurality of functions is implemented as a set of tasks serviced by the one or more processors 1404 as needed or desired. In one example, the multitasking environment may be implemented using a timesharing program 1420 that passes control of a processor 1404 between different tasks, whereby each task returns control of the one or more processors 1404 to the timesharing program 1420 upon completion of any outstanding operations and/or in response to an input such as an interrupt. When a task has control of the one or more processors 1404, the processing circuit is effectively specialized for the purposes addressed by the function associated with the controlling task. The timesharing program 1420 may include an operating system, a main loop that transfers control on a round-robin basis, a function that allocates control of the one or more processors 1404 in accordance with a prioritization of the functions, and/or an interrupt driven main loop that responds to external events by providing control of the one or more processors 1404 to a handling function.

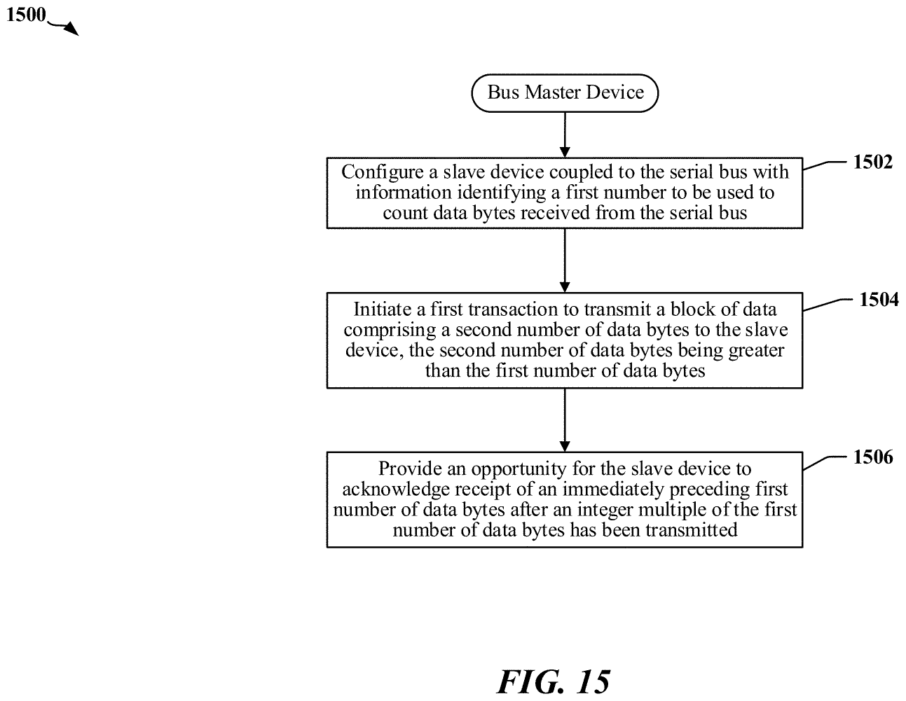

FIG. 15 is a flowchart 1500 illustrating a method that may be performed at a master device coupled to a serial bus. The serial bus may be operated in accordance with one or more I3C protocols. The method may relate to managing transactions executed on a serial bus, including the provision of ACK/NACK opportunities within a transaction and before all data in the transaction has been transmitted.

At block 1502, the master device may configure a slave device coupled to the serial bus with information identifying a first number to be used to count data bytes received from the serial bus. At block 1504, the master device may initiate a first transaction to transmit a block of data that has a second number of data bytes to the slave device, the second number being greater than the first number. At block 1506, the master device may provide an opportunity for the slave device to acknowledge receipt of an immediately preceding first number of data bytes after an integer multiple of the first number of data bytes has been transmitted.

In certain implementations, the master device may terminate the first transaction when the slave device does not acknowledge receipt of the immediately preceding first number of data bytes, and retransmit the immediately preceding first number of data bytes in a second transaction. The master device may continue transmission of the block of data after the retransmission. For example, the master device may resume transmission of the block of data from a location in the block of data at which the opportunity for the slave device to acknowledge receipt of the immediately preceding first number of data bytes was provided, after retransmitting the immediately preceding first number of data bytes.

In one example, an opportunity for the slave device to acknowledge receipt of an immediately preceding first number of data bytes may be provided by causing an output of a line driver to enter an undriven state after transmitting a last data byte in the integer multiple of the first number of data bytes.

In certain implementations, an opportunity for the slave device to acknowledge receipt of an immediately preceding first number of data bytes may be provided by providing an extra data byte for transmission after a last data byte in the integer multiple of the first number of data bytes, transmitting eight bits of the extra data byte after the last data byte in the integer multiple of the first number of data bytes has been transmitted, and providing a ninth bit in the extra data byte by causing an output of a line driver to enter an undriven state. The extra data byte may be provided by transmitting a CRC code in the extra data byte. The CRC code may be calculated from the immediately preceding first number of data bytes. The CRC code may be calculated from data bytes in the block of data that have been transmitted before the extra data byte is transmitted. An extra data byte may be provided by providing parity information in the extra data byte, the parity information relating to the CRC code. Providing an extra data byte may include providing parity information in the extra data byte. the parity information being generated from the immediately preceding first number of data bytes.

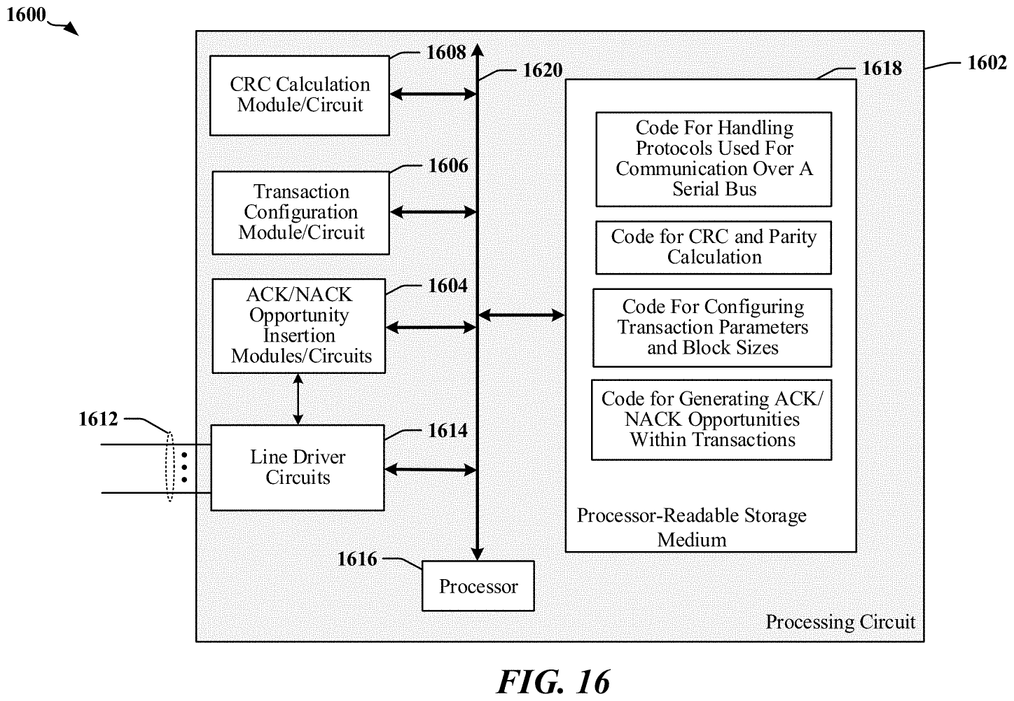

FIG. 16 is a diagram illustrating an example of a hardware implementation for an apparatus 1600 employing a processing circuit 1602. In one example, the apparatus 1600 is configured for data communication over a serial bus that is operated in accordance with one or more I3C protocols. The processing circuit 1602 typically has a controller or processor 1616 that may include one or more microprocessors, microcontrollers, digital signal processors, sequencers and/or state machines. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the controller or processor 1616, the modules or circuits 1604, 1606 and 1608, and the processor-readable storage medium 1618. The apparatus 1600 may be coupled to a multi-wire communication link using a physical layer circuit 1614. The physical layer circuit 1614 may operate the multi-wire serial bus 1612 to support communications in accordance with I3C protocols. The bus 1620 may also link various other circuits such as timing sources, peripherals, voltage regulators, and power management circuits, which are well known in the art, and therefore, will not be described any further.

The processor 1616 is responsible for general processing, including the execution of software, code and/or instructions stored on the processor-readable storage medium 1618. The processor-readable storage medium 1618 may include non-transitory storage media. The software, when executed by the processor 1616, causes the processing circuit 1602 to perform the various functions described supra for any particular apparatus. The processor-readable storage medium 1618 may be used for storing data that is manipulated by the processor 1616 when executing software. The processing circuit 1602 further includes at least one of the modules 1604, 1606 and 1608. The modules 1604, 1606 and 1608 may be software modules running in the processor 1616, resident/stored in the processor-readable storage medium 1618, one or more hardware modules coupled to the processor 1616, or some combination thereof. The modules 1604, 1606 and 1608 may include microcontroller instructions, state machine configuration parameters, or some combination thereof.

In one configuration, the apparatus 1600 includes physical layer circuit 1614 that may include one or more line driver circuits coupled to the multi-wire serial bus 1612. The apparatus 1600 includes modules and/or circuits 1608 configured to calculate CRC codes from data transmitted over the multi-wire serial bus 1612, modules and/or circuits 1606 configured to manage block sizes and other aspects of a transaction conducted over the multi-wire serial bus 1612, and modules and/or circuits 1604 configured to provide ACK/NACK opportunities within a transaction conducted over the multi-wire serial bus 1612.

In one example, the apparatus 1600 includes a processor 1616 configured to configure a slave device coupled to the multi-wire serial bus 1612 with information identifying a first number to be used to count data bytes received from the multi-wire serial bus 1612, initiate a first transaction to transmit a block of data that has a second number of data bytes to the slave device, the second number being greater than the first number, and provide an opportunity for the slave device to acknowledge receipt of an immediately preceding first number of data bytes after an integer multiple of the first number of data bytes has been transmitted. The number bytes received from the multi-wire serial bus 1612 may be counted by a counter of the physical layer circuit 1614 and/or by a protocol handler of the apparatus 1600.

In some implementations, the processor 1616 is further configured to terminate the first transaction when the slave device does not acknowledge receipt of the immediately preceding first number of data bytes, and retransmit the immediately preceding first number of data bytes in a second transaction. The processor 1616 may be further configured to continue transmission of the block of data from a location in the block of data at which the opportunity for the slave device to acknowledge receipt of the immediately preceding first number of data bytes was provided, after the immediately preceding first number of data bytes has been transmitted.

In one implementation, The processor 1616 is further configured to cause an output of a line driver in a bus interface (e.g., the physical layer circuit 1614) to enter an undriven state after transmitting a last data byte in the integer multiple of the first number of data bytes.

In certain implementations, the processor 1616 is further configured to provide an extra data byte for transmission after a last data byte in the integer multiple of the first number of data bytes, transmit eight bits of the extra data byte after the last data byte in the integer multiple of the first number of data bytes has been transmitted, and provide a ninth bit in the extra data byte by causing an output of a line driver to enter an undriven state. The processor 1616 may be further configured to provide a CRC code in the extra data byte. The CRC code may be calculated from the immediately preceding first number of data bytes. The CRC code may be calculated from data bytes in the block of data that have been transmitted before the extra data byte is transmitted. The processor 1616 may be further configured to provide parity information in the extra data byte. The parity information may relate to the CRC code. The parity information may be generated from the immediately preceding first number of data bytes.

The processor-readable storage medium 1618 may include instructions that cause the processing circuit 1602 to configure a slave device coupled to the multi-wire serial bus 1612 with information identifying a first number to be used to count data bytes received from the multi-wire serial bus 1612, initiate a first transaction to transmit a block of data that has a second number of data bytes to the slave device, the second number being greater than the first number, and provide an opportunity for the slave device to acknowledge receipt of an immediately preceding first number of data bytes after an integer multiple of the first number of data bytes has been transmitted.

The processor-readable storage medium 1618 may include instructions that cause the processing circuit 1602 to terminate the first transaction when the slave device does not acknowledge receipt of the immediately preceding first number of data bytes, and retransmit the immediately preceding first number of data bytes in a second transaction. The processor-readable storage medium 1618 may include instructions that cause the processing circuit 1602 to continue transmission of the block of data from a location in the block of data at which the opportunity for the slave device to acknowledge receipt of the immediately preceding first number of data bytes was provided, after retransmitting the immediately preceding first number of data bytes.

The processor-readable storage medium 1618 may include instructions that cause the processing circuit 1602 to cause an output of a line driver to enter an undriven state after transmitting a last data byte in the integer multiple of the first number of data bytes. The processor-readable storage medium 1618 may include instructions that cause the processing circuit 1602 to provide an extra data byte for transmission after a last data byte in the integer multiple of the first number of data bytes, transmit eight bits of the extra data byte after the last data byte in the integer multiple of the first number of data bytes has been transmitted, and provide a ninth bit in the extra data byte by causing an output of a line driver to enter an undriven state. The processor-readable storage medium 1618 may include instructions that cause the processing circuit 1602 to provide a CRC code in the extra data byte. The CRC code may be calculated from at least the immediately preceding first number of data bytes. The processor-readable storage medium 1618 may include instructions that cause the processing circuit 1602 to provide parity information in the extra data byte. In one example, the parity information relates to the CRC code. In another example, the parity information is generated from the immediately preceding first number of data bytes.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for managing transactions executed on a serial bus, comprising:
configuring a slave device coupled to the serial bus with information identifying a first number to be used to count data bytes received from the serial bus;
initiating a first transaction to transmit a block of data comprising a second number of data bytes to the slave device, the second number being greater than the first number; and
providing an opportunity for the slave device to acknowledge receipt of an immediately preceding first number of data bytes after an integer multiple of the first number of data bytes has been transmitted.

2. The method of claim 1, further comprising:
terminating the first transaction when the slave device does not acknowledge the receipt of the immediately preceding first number of data bytes; and
retransmitting the immediately preceding first number of data bytes in a second transaction.

3. The method of claim 2, further comprising:
continuing transmission of the block of data from a location in the block of data at which the opportunity for the slave device to acknowledge the receipt of the immediately preceding first number of data bytes was provided, after retransmitting the immediately preceding first number of data bytes.

4. The method of claim 1, wherein providing the opportunity for the slave device to acknowledge the receipt of the immediately preceding first number of data bytes comprises:
causing an output of a line driver to enter an undriven state after transmitting a last data byte in the integer multiple of the first number of data bytes.

5. The method of claim 1, wherein providing the opportunity for the slave device to acknowledge the receipt of the immediately preceding first number of data bytes comprises:
providing an extra data byte for transmission after a last data byte in the integer multiple of the first number of data bytes;
transmitting eight bits of the extra data byte after the last data byte in the integer multiple of the first number of data bytes has been transmitted; and
providing a ninth bit in the extra data byte by causing an output of a line driver to enter an undriven state.

6. The method of claim 5, wherein providing the extra data byte comprises:
providing a cyclic redundancy check (CRC) code in the extra data byte.

7. The method of claim 6, wherein the CRC code is calculated from the immediately preceding first number of data bytes.

8. The method of claim 6, wherein the CRC code is calculated from data bytes in the block of data that have been transmitted before the extra data byte is transmitted.

9. The method of claim 6, wherein providing the extra data byte comprises:
providing parity information in the extra data byte, wherein the parity information relates to the CRC code.

10. The method of claim 5, wherein providing the extra data byte comprises:
providing parity information in the extra data byte, wherein the parity information is generated from the immediately preceding first number of data bytes.

11. An apparatus configured for managing transactions executed on a serial bus, comprising:
a bus interface configured to couple the apparatus to the serial bus; and
a processor configured to:
configure a slave device coupled to the serial bus with information identifying a first number to be used to count data bytes received from the serial bus;
initiate a first transaction to transmit a block of data comprising a second number of data bytes to the slave device, the second number being greater than the first number; and
provide an opportunity for the slave device to acknowledge receipt of an immediately preceding first number of data bytes after an integer multiple of the first number of data bytes has been transmitted.

12. The apparatus of claim 11, wherein the processor is further configured to:
terminate the first transaction when the slave device does not acknowledge the receipt of the immediately preceding first number of data bytes; and
retransmit the immediately preceding first number of data bytes in a second transaction.

13. The apparatus of claim 12, wherein the processor is further configured to:
continue transmission of the block of data from a location in the block of data at which the opportunity for the slave device to acknowledge the receipt of the immediately preceding first number of data bytes was provided, after retransmitting the immediately preceding first number of data bytes.

14. The apparatus of claim 11, wherein the processor is further configured to:
cause an output of a line driver in the bus interface to enter an undriven state after transmitting a last data byte in the integer multiple of the first number of data bytes.

15. The apparatus of claim 11, wherein the processor is further configured to:
provide an extra data byte for transmission after a last data byte in the integer multiple of the first number of data bytes;
transmit eight bits of the extra data byte after the last data byte in the integer multiple of the first number of data bytes has been transmitted; and
provide a ninth bit in the extra data byte by causing an output of a line driver to enter an undriven state.

16. The apparatus of claim 15, wherein the processor is further configured to:
provide a cyclic redundancy check (CRC) code in the extra data byte.

17. The apparatus of claim 16, wherein the CRC code is calculated from the immediately preceding first number of data bytes.

18. The apparatus of claim 16, wherein the CRC code is calculated from data bytes in the block of data that have been transmitted before the extra data byte is transmitted.

19. The apparatus of claim 16, wherein the processor is further configured to:
provide parity information in the extra data byte, wherein the parity information relates to the CRC code.

20. The apparatus of claim 15, wherein the processor is further configured to:
provide parity information in the extra data byte, wherein the parity information is generated from the immediately preceding first number of data bytes.

21. A processor-readable storage medium including code which, when executed by a processor, causes the processor to:
configure a slave device coupled to a serial bus with information identifying a first number to be used to count data bytes received from the serial bus;
initiate a first transaction to transmit a block of data comprising a second number of data bytes to the slave device, the second being greater than the first number; and
provide an opportunity for the slave device to acknowledge receipt of an immediately preceding first number of data bytes after an integer multiple of the first number of data bytes has been transmitted.

22. The storage medium of claim 21, further comprising code that causes the processor to:
terminate the first transaction when the slave device does not acknowledge the receipt of the immediately preceding first number of data bytes; and
retransmit the immediately preceding first number of data bytes in a second transaction.

23. The storage medium of claim 22, further comprising code that causes the processor to:
continue transmission of the block of data from a location in the block of data at which the opportunity for the slave device to acknowledge the receipt of the immediately preceding first number of data bytes was provided, after retransmitting the immediately preceding first number of data bytes.

24. The storage medium of claim 21, further comprising code that causes the processor to:
cause an output of a line driver to enter an undriven state after transmitting a last data byte in the integer multiple of the first number of data bytes.

25. The storage medium of claim 21, further comprising code that causes the processor to:
provide an extra data byte for transmission after a last data byte in the integer multiple of the first number of data bytes;
transmit eight bits of the extra data byte after the last data byte in the integer multiple of the first number of data bytes has been transmitted; and
provide a ninth bit in the extra data byte by causing an output of a line driver to enter an undriven state.

26. The storage medium of claim 25, further comprising code that causes the processor to:
provide a cyclic redundancy check (CRC) code in the extra data byte.

27. The storage medium of claim 26, wherein the CRC code is calculated from the immediately preceding first number of data bytes.

28. The storage medium of claim 26, further comprising code that causes the processor to:
provide parity information in the extra data byte, wherein the parity information relates to the CRC code.

29. The storage medium of claim 25, further comprising code that causes the processor to:
provide parity information in the extra data byte, wherein the parity information is generated from the immediately preceding first number of data bytes.

30. An apparatus configured for data communication, comprising:
means for configuring a slave device coupled to a serial bus with information identifying a first number to be used to count data bytes received from the serial bus;
means for initiating a first transaction to transmit a block of data comprising a second number of data bytes to the slave device, the second number being greater than the first number; and
means for providing an opportunity for the slave device to acknowledge receipt of an immediately preceding first number of data bytes after an integer multiple of the first number of data bytes has been transmitted.
